(19) United States
(12) Patent Application Publication
(10) Pub. No.: US 2022/0194749 A1
(43) Pub. Date: Jun. 23, 2022

(54) CRANE AND METHOD FOR CONTROLLING SUCH A CRANE

(71) Applicant: Liebherr-Werk Biberach GmbH, Biberach an der Riss (DE)

(72) Inventor: Tobias Englert, Laupheim (DE)

(73) Assignee: Liebherr-Werk Biberach GmbH, Biberach an der Riss (DE)

(21) Appl. No.: 17/652,476

(22) Filed: Feb. 24, 2022

Related U.S. Application Data
(63) Continuation of application No. PCT/EP2020/072262, filed on Aug. 7, 2020.

(30) Foreign Application Priority Data
Aug. 26, 2019 (DE) 10 2019 122 796.8

(51) Int. Cl. B66C 13/06; B66C 13/08; G01C 19/00; G01P 15/08; G06T 7/70

(52) U.S. Cl. CPC B66C 13/063; B66C 13/085; G06T 7/70; G01P 15/08; G01C 19/00

(57) ABSTRACT

The invention relates to a crane, in particular a revolving tower crane or boom crane, having a hoisting cable which extends from a crane boom and carries a load hook, wherein a sling having a load fixed thereto is rigged to the load hook, which load hangs down, spaced apart from the load hook by the sling, and having a determination device for determining the position and/or excursion of the load, and an electronic control apparatus for controlling drive devices for moving crane elements and relocating the load hook according to the detected position and/or excursion of the load, wherein the determination device has first determining means for determining a position and/or excursion of the load hook and furthermore an inertial measurement unit which is attached to the sling and/or the load and which has acceleration and rotation rate sensor means for providing acceleration and rotation rate signals and second determination means for determining and/or estimating an excursion and/or position of the load from the acceleration and rotation rate signals of the inertial measurement unit, which is attached to the sling and/or to the load, and from the signals of the indicated first determination means which characterize the position and/or excursion of the load hook.

### CROSS-REFERENCE TO RELATED APPLICATIONS

This application is a continuation of International Patent Application Number PCT/EP2020/072262 filed Aug. 7, 2020, which claims priority to German Patent Application Number DE 10 2019 122 796.8 filed Aug. 26, 2019, the contents of which are incorporated herein by reference in their entireties.

### BACKGROUND

The present invention relates to a crane, in particular a revolving tower crane, having a hoisting cable which extends from a crane boom and carries a load hook to which a sling carrying a load is rigged, a determination device for determining the position and/or pendulum movements of the load, drive devices for moving crane elements and relocating the load hook, and a control apparatus for controlling the drive devices depending on the given load position and/or pendulum movements, as well as further a method for controlling such a crane, at which the control of the drive devices is influenced depending on the given load position and/or pendulum movements.

To be able to relocate the load hook of a crane along a travel path or between two destination points, various drive devices typically have to be actuated and controlled.

Operators of for example tower revolving cranes, boom cranes (or ship-to-shore cranes) usually control the drives directly, so it requires a lot of practice and concentration to be able to move a load quickly to the discharge point and to place it safely there. In particular, large pendulum vibrations of the load sometimes occur due to the control of the crane, and only decay very slowly. Avoiding this manually is very difficult and even experienced crane operators do not always or hardly succeed.

The complexity of the pendulum movements is increased even further if the load cannot be suspended directly from the load hook, but is attached via a sling, for example in the form of a cable system, an intermediate hanger, one or more chains, an extended lifting net or simply further cables, hung down, spaced apart a short distance from the load hook. The longer the sling is in relation to the lowering depth and depending on the ratio of the load mass and the mass of the load hook or bottom hook block, the influence or proportion of the pendulum movements of the load in relation to the load hook varies. Double pendulum movements occur, in which the pendulum movements of the load hook are superimposed on the pendulum movements of the load spaced from the hook or the sling. This superimposition of pendulum movements makes it even more difficult for the crane operator to operate the drives in such a way that the double pendulum movements are damped or do not occur at all.

What also occurs with some crane types is that the crane structure is inherently compliant and can swing itself, which is hardly predictable by the crane operator taking into account a variety of movement axes. For example with a revolving tower crane in which the hoisting cable extends from a trolley that is travellable at the boom of the crane, the slewing gear by means of which the tower with the boom or booms provided thereon are rotated about an upright axis of rotation relative to the tower, the trolley drive by means of which the trolley can be travelled along the boom, and the hoisting gear by means of which the hoisting cable can be adjusted and thus the load hook can be raised and lowered, typically respectively have to be actuated and controlled. With cranes having a luffable telescopic boom, in addition to the slewing gear that rotates the boom or the superstructure carrying the boom about an upright axis and in addition to the hoisting gear for adjusting the hoisting cable, the luffing drive for luffing the boom up and down and the telescopic drive for traveling the telescopic sections in and out are also actuated, optionally also a luffing fly drive on the presence of a luffing fly jib at the telescopic boom. In mixed forms of such cranes and in similar crane types, for example tower cranes having a luffable boom or derrick cranes having a luffable counter-boom, further drive devices can also respectively have to be controlled.

Said drive devices are here typically actuated and controlled by the crane operator via corresponding operating elements such as in the form of joysticks, rocker switches, rotary knobs, and sliders and the like, which, as experience has shown, requires a lot of feeling and experience to travel to the destination points fast and nevertheless gently without any greater pendulum movements of the load hook. Whereas travel between the destination points should be as fast as possible to achieve high work performance, the stop at the respective destination point should be gentle without the load hook with the load lashed thereto continuing to oscillate.

Such a control of the drive devices of a crane is tiring for the crane operator in view of the required concentration, particularly since often continuously repeating travel paths and monotonous work have to be dealt with. In addition, pendulum movements or double pendulum movements of the suspended load and thus a corresponding hazard potential occur as concentration decreases or also with insufficient experience with the respective crane type if the crane operator does not operate the operating levers or operating elements of the crane sensitively enough. In practice, large pendulum vibrations of the load sometimes occur fast over and over again, even with experienced crane operators due to the control of the crane, and only decay very slowly.

It has already been proposed to counteract the problem of unwanted pendulum movements to provide the control apparatus of the crane with pendulum damping device that intervene in the control by means of control modules and influence the control of the drive devices, for example, prevent or reduce accelerations that are too large of a drive device due to too fast or too strong an actuation of the operating lever or restrict specific travel speeds with larger loads or actively intervene in a similar manner in the travel movements to prevent too great a pendulum of the load hook.

Such pendulum damping devices for cranes are known in various embodiments, for example by controlling the slewing gear drive, the luffing drive, and the trolley drive in dependence on specific sensor signals, for example inclination signals and/or gyroscope signals. Documents DE 20 2008 018 260 U1 or DE 10 2009 032 270 A1, for example, show known load pendulum damping device at cranes and their subject matters are expressly referenced to this extent, that is, with respect to the principles of the pendulum damping device. In DE 20 2008 018 260 U1, for example, the cable angle relative to the vertical and its change is measured by means of a gyroscope unit in the form of the cable angle speed to automatically intervene in the control on an exceeding of a limit value for the cable angle speed with respect to the vertical.

Documents EP16 28 902 B1, DE 103 24 692 A1, EP25 62 125 B1, US 2013 01 61 279 A, DE100 64 182 A1, oder U.S. Pat. No. 5,526,946 furthermore each show concepts for a closed-loop regulation of cranes that take account of pendulum dynamics or also pendulum dynamics and drive dynamics. Such closed-loop regulations on cranes while taking account of the pendulum dynamics also form the subject matter of various scientific publications, cf. e.g. E. Arnold, O. Sawodny, J. Neupert and K. Schneider, “Anti-sway system for boom cranes based on a model predictive control approach”, IEEE International Conference Mechatronics and Automation, 2005, Niagara Falls, Ont., Canada, 2005, pp. 1533-1538 Vol. 3, and Arnold, E., Neupert, J., Sawodny, O., “Model-predictive trajectory generation for flatness-based follow-up controls for the example of a harbor mobile crane”, at—Automatisierungstechnik, 56 (August 2008), or J. Neupert, E. Arnold, K. Schneider & O. Sawodny, “Tracking and anti-sway control for boom cranes”, Control Engineering Practice, 18, pp. 31-44, 2010, doi: 10.1016/j.conengprac.2009.08.003.

Furthermore, it has already been attempted to model double pendulum movements, which occur in the manner described when the load is spaced apart from the load hook by means of a sling, cf. Schaper, Ulf et al “A load position observer for cranes with gyroscope measurements” in: Proceedings of the 18^{th} World Congress, the International Federation of Automatic Control, Milano (Italy), Aug. 28-Sep. 2, 2011, pages 3563 to 3568. A gyroscope is used to measure the deflection angle and the deflection acceleration of the hoisting cable in order to determine the position of the load hung down from the sling on the basis of the kinematic model of the double pendulum. This however requires knowledge of the length of the additional sling or the distance between the load and the hook as well as the inertia moment of the load and the sling. Without the additional knowledge of the length of the sling or the load distance from the hook or the inertia moment of the load and the sling related to the crane hook, this approach cannot reliably determine the position of the load or the deflection thereof.

The principal objective is therefore to detect or determine the load position or its double pendulum movements as precisely as possible in order to be able to actively counteract them by means of a regulation. On the one hand, such a control can serve as an assistance system that allows the crane operator to directly specify the load movement using the control units (instead of the bridge or trolley movement). Thanks to such support, occupational safety and productivity can be increased. What is also an important precondition for the full automation of bridge cranes is the damping of vibrations.

A particular issue here is that systems for active vibration damping could not be cost-effectively upgraded or were not universally applicable. Further disadvantages result from the fact that so far the known vibration damping systems based on pendulum angle measurements have been quite expensive, and generally insufficient consideration is given to possible double pendulum movements, as they occur in the case of elongated slings with accompanying spacing apart of the load from the load hook due to the superimposition of pendulum movements of the load hook itself and pendulum movements of the load relative to the load hook.

### SUMMARY

Proceeding therefrom, the present invention is based on the task of creating an improved crane as well as an improved method for its control, which avoid the disadvantages of the prior art and further develop the latter in an advantageous manner. Preferably, the aim is to achieve an improved sway damping system for revolving tower cranes, boom cranes or other cranes, which better takes into account the double pendulum movements in the case of extended slings and loads hanging down, spaced apart from the load hook.

Said task is solved, according to the invention, with a crane as claimed in claim 1 and a method as claimed in claim 10. Preferred embodiments of the invention are the subject-matter of the dependent claims.

It is therefore proposed to perform pendulum detection on the sling and/or directly on the load hung down, spaced apart from the load hook itself, and to provide the pendulum sensor on the sling and/or directly on the load hung down, spaced apart from the load hook, with an inertial detection device, which is mounted on the sling and/or directly on the load suspended at a distance from the load hook and provides acceleration and rotation rate signals which represent translational accelerations and rotation rates of the sling and/or the load suspended at a distance from the load hook.

Such an inertial measurement unit attached to the sling and/or directly to the load hung down, spaced apart from the load hook, that is sometimes also called an IMU, can have acceleration and rotation rate sensor means for providing acceleration signals and rotation rate signals that indicate, on the one hand, translatory accelerations along different spatial axes and, on the other hand, rotational rates or gyroscopic signals with respect to different spatial axes. Rotational speeds, but generally also rotational accelerations, or also both, can here be provided as rotational rates.

From the acceleration and rotation rate signals of said inertial measurement unit, which is attached directly to the sling or the load attached to it, and the load hook position and/or deflection or the measurement signals that characterize or allow the load hook position and/or deflection to be identified, based on the dynamics of a double pendulum, the load position or deflection can be determined very precisely.

The load hook position and/or deflection can be determined in a manner known per se, for example, by a pendulum sensor that has a camera in the area of the discharge point of the hoisting cable from the boom and/or has a gyroscope on the hoisting cable and/or comprises a further inertial measurement unit on the load hook.

Due to the additional pendulum sensor on said sling and/or directly on the load hanging down from the load hook by the sling and its inertial measurement unit which provides acceleration and rotation rate signals of the load or the sling, the load position and/or deflection can be precisely determined even in double pendulum movements without the need to know exactly the length of the sling or the distance of the load from the load hook and the inertia moment of the load and the sling in relation to the crane hook. In particular, this allows the load position and/or deflection to be determined precisely even if loads of different weights are lifted or slings of different lengths are used during crane operation, or if a sling is tied down at different lengths, as frequently takes place in practice.

Said inertial measurement unit can advantageously be attached to the load and/or to the sling in a detachable and/or tool-free manner, wherein fastening means for fastening the inertial measurement unit can comprise, for example, a magnetic device or an elastic clamping device in order to be able to magnetically fasten or clamp the inertial measurement unit to the load and/or to the sling in a simple manner. Other fastening means such as a vacuum suction button or mechanically actuated clamping means such as clamping claws can also be used.

In particular, on the basis of the dynamics of the double pendulum, an observer can be provided, for example in the form of a Kalman filter, in particular a non-linear or so-called “unscented” Kalman filter, which, with the aid of position and velocity signals of all drives as well as the load hook position and/or deflection, or using signals of the pendulum sensors, which identify the load hook position and/or deflection, and the additional pendulum sensor systems in the form of the inertial measurement unit on the load itself or on the sling, the position and/or deflection of the load can be determined reliably and precisely. Here, for example, the length of the sling and/or the distance of the load from the load hook and/or the deflection angle between the sling and the vertical can be estimated and the position of the load calculated therefrom.

The inertial measurement unit can advantageously detect accelerations in three spatial axes and rotational rates about at least two spatial axes. The acceleration sensor means can be configured as working in three axes and the gyroscope sensor means can be configured as working at least in two axes.

The inertial measurement unit attached to the sling and/or directly to the load hung down, spaced apart from the load hook can advantageously transmit its acceleration signals and rotational rate signals and/or signals derived therefrom wirelessly to a control and/or evaluation unit that can be attached to a structural part of the crane or that can also be arranged separately close to the crane. The transmission can in particular take place to a receiver that can be attached to the trolley and/or to the suspension from which the hoisting cable extends. The transmission can advantageously take place via a Bluetooth or a wireless LAN connection, for example.

A pendulum damping can also be very simply retrofitted to existing cranes by such a wireless connection of an inertial measurement unit without complex retrofitting measures being required for this purpose. Substantially only the inertial measurement unit has to be attached to the sling and/or directly to the load hung down, spaced apart from the load hook, and the receiver communicating with it, which transmits the signals to the control device or regulation unit.

From the signals of the inertial measurement unit, the deflection of the load or of the sling on which the load is hung from the load hook can advantageously be determined in a two- or multi-stage process with respect to the vertical. First, the tilt of the sling and/or the tilt of the load is controlled using, for example, a complementary filter or an orientation filter see, for example, Mahony, R.; Hamel, T. & Pflimlin, J., Nonlinear Complementary Filters on the Special Orthogonal Group, IEEE Transactions on Automatic Control, 2008, 53, 1203-1218, oder Madgwick, S. O. H.; Harrison, A. J. L. & Vaidyanathan, R., Estimation of IMU and MARG orientation using a gradient descent algorithm, IEEE International Conference on Rehabilitation Robotics, 2011, 1-7, as these need not coincide with the deflection of the load hook relative to the trolley or suspension point and the deflection of the hoisting cable relative to the vertical, and then the sought deflection of the sling or load hung down from the load hook relative to the vertical is determined from the tilt of the sling and/or load and its acceleration. Since the inertial measurement unit is attached to the sling and/or directly to the load hung down, spaced apart from the load hook, the acceleration and rotation rate signals are influenced both by the pendulum movements of the hoisting cable and by the dynamics of the sling tilting or swinging relative to the hoisting cable.

In particular, a few calculation steps can provide an accurate estimate of the load pendulum angle and/or the load position, which can then be used by the controller—in particular together with the load hook position and/or the pendulum angle of the load hook/and/or the hoisting cable—for active pendulum damping.

Advantageously, the tilt of the sling and/or the load hung down, spaced apart from the load hook, is first determined from the signals of the inertial measurement unit using a complementary filter, which makes use of the different characteristics of the translational acceleration signals and the gyroscopic signals of the inertial measurement unit, wherein alternatively or additionally, however, a Kalman filter can also be used to determine the tilt of the sling and/or the load hung down, spaced apart from the load hook, from the acceleration signals and the rotation rate signals.

From the determined tilting of the sling and/or the load hanging down spaced apart from the load hook, the accelerations and rotation rates of the load or the sling can then be determined in inertial coordinates.

Said first determination means may in particular comprise a complementary filter comprising a highpass filter for the rotation rate signal of the inertial measurement unit and a lowpass filter for the acceleration signal of the inertial measurement unit or a signal derived therefrom, wherein said complementary filter may be configured to combine a rotation rate-based estimate of sling or load tilt based on the highpass filtered rotation rate signal and an acceleration-based estimate of sling or load tilt based on the lowpass filtered acceleration signal, and to determine the sought tilt of the load-receiving means from the combined rotation rate-based and acceleration-based estimates of the tilt of the load-receiving means.

Said second determination means for determining the deflection of the sling or the load with respect to the vertical on the basis of the determined tilt of the load-receiving means can have a filter and/or an observer device which takes into account the determined tilt of the load-receiving means as an input variable and determines the deflection of the sling or the load with respect to the vertical from an inertial acceleration on the sling or the load.

Said filter device and/or observer device can in particular comprise a Kalman filter, in particular an extended or non-linear “scented” Kalman filter.

Alternatively or additionally to such a Kalman filter, the second determination means can also have a calculation device for calculating the deflection of the hoisting cable and/or of the load-receiving means with respect to the vertical from a static relationship of the accelerations, in particular from the quotient of a horizontal inertial acceleration and acceleration due to gravity.

Advantageously, a pendulum sensor can be assigned to the upper portion of the double pendulum, i.e. to the hoisting cable and/or the load hook attached thereto, for detecting this component of the double pendulum movement in order to be able to determine the deflection of the hoisting cable and/or the load hook relative to the vertical and/or the load hook position from signals of the pendulum sensor.

In particular, the pendulum sensor for measuring the upper component of the double pendulum motion may include a gyroscope device capable of measuring deflections of the hoisting cable. Such a gyroscope device associated with the hoisting cable is known per se and can be found, for example, in the previously specified document Schaper Ulf et al “A load position observer for cranes with gyroscope measurements”.

Alternatively or in addition to such a gyroscope device, the pendulum sensor for detecting the pendulum movements of the load hook can also have an inertial measurement unit on the load hook, which provides acceleration and rotation rate signals that indicate, on the one hand, translational accelerations along various spatial axes and, on the other hand, rotation rates or gyroscopic signals with respect to various spatial axes and reflect the translational accelerations and rotation rates of the load hook. As rotation rates there can be provided rotational speeds, but in principle also rotational accelerations or both.

The evaluation of the acceleration and rotation rate signals of the IMU attached to the load hook can basically be done analogously to the evaluation of the acceleration and rotation rate signals of the IMU attached directly to the load or to the sling, as described before.

The detection device for the position detection of the load hook can advantageously comprise an imaging sensor system, for example a camera, that looks substantially straight down from the suspension point of the hoisting cable, for example the trolley. An image evaluation device can identify the crane hook in the image provided by the imaging sensor system and can determine its eccentricity or its displacement from the image center therefrom that is a measure for the deflection of the crane hook with respect to the vertical and thus characterizes the load pendulum. Alternatively or additionally, a gyroscopic sensor can detect the hoisting cable retraction angle from the boom and/or with respect to the vertical and supply it to the Kalman filter.

With an articulated connection of the load hook to the hoisting cable, the orientation of the load hook can correspond to the orientation of the slinging means. Accordingly, it may be sufficient that on the load hook there were attached only one inertial measurement unit and that there was no need for a further inertial measurement unit on the sling and/or on the load, since the inertial measurement unit on the load hook provides acceleration and rotation rate signals which also characterize the deflection of the sling and the load attached thereto. In this case, with a single inertial measurement unit on the load hook, there can be determined the position or the pendulum angles of both the load and the load hook itself.

The tilt of the load hook and the sling or the lower pendulum angle of the double pendulum can be obtained directly from the estimate of the orientation filter, which can, for example, be implemented as a complementary filter. In this case, the deflection angle of the load hook and the sling attached to it with respect to the vertical and the corresponding angular velocity do not represent states of the system, but represent inputs. The length of the sling can be estimated using a random walk approach. Alternatively or additionally, the length of the sling can also be transferred to the observer from outside and/or from a higher-level software module.

Said pendulum damping device can monitor the input commands of the crane operator on a manual actuation of the crane by actuating corresponding operating elements such as joysticks and the like and can override them as required, in particular in the sense that accelerations that are, for example, specified as too great by the crane operator are reduced or also that counter-movements are automatically initiated if a crane movement specified by the crane operator has resulted or would result in an pendulum of the load hook. The regulation module in this respect advantageously attempts to remain as close as possible to the movements and movement profiles desired by the crane operator to give the crane operator a feeling of control and overrides the manually input control signals only to the extent it is necessary to carry out the desired crane movement as free of pendulums and vibrations as possible. Alternatively or additionally, the control element(s) such as one or more joysticks can be used to specify not the speed of the drives but the speed of the load, with the controller component or the control apparatus controlling the crane drives in such a way that the specifications are implemented as well as possible, but at the same time the load does not start to swing.

Alternatively or additionally, the pendulum damping device can also be used on an automated actuation of the crane in which the control apparatus of the crane automatically travels the load-receiving means of the crane between at least two destination points along a travel path in the sense of an autopilot. In such an automatic operation in which a travel path determination module of the control apparatus determines a desired travel path, for example in the sense of a path control and an automatic travel control module of the control apparatus controls the drive regulator or drive devices such that the load hook is traveled along the specified travel path, the pendulum damping device can intervene in the control of the drive regulator by said travel control module to travel the crane hook free of pendulums or to damp pendulum movements.

### BRIEF DESCRIPTION OF THE DRAWINGS

The invention is explained in more detail below on the basis of a preferred exemplary embodiment and the corresponding drawings. The drawings show:

FIG. 1 shows a schematic representation of a revolving tower crane in which a hoisting cable extends from a trolley which can be moved on a boom and on which a load hook is articulated, wherein on the load hook there is suspended a sling, wherein the double pendulum movements possible through this are shown with different deflection angles of the hoisting cable and the sling;

FIG. 2 shows a schematic representation of the double pendulum from FIG. 1 and its hinging to a crane trolley, wherein the travel movements of the trolley, the length changes of the hoisting cable and the resulting pendulum angles are entered;

FIG. 3 shows a possible tilting of the load hook with respect to the hoisting cable; and

FIG. 4 shows a schematic representation of a revolving tower crane and the double pendulum comprising the hoisting cable and the sling hinged to the load hook, wherein the load hook is connected to the hoisting cable by an articulated connection and the deflection of the load hook corresponds to the def of the sling.

### DETAILED DESCRIPTION

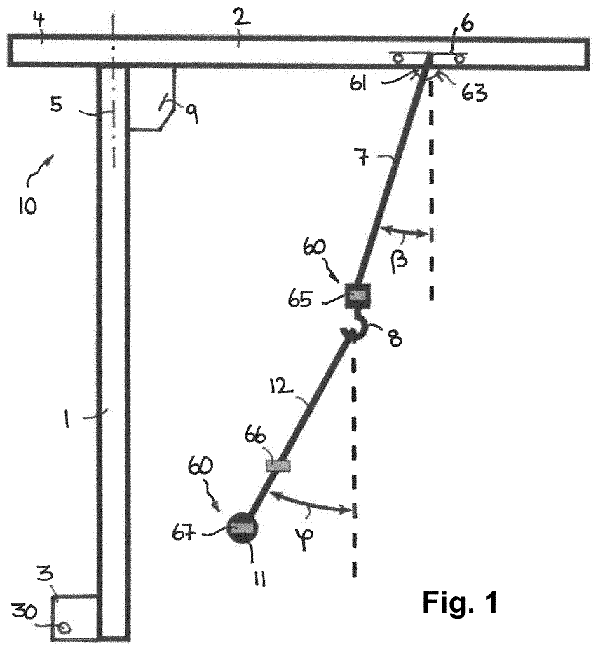

As FIG. 1 shows, the crane 10 can be configured as a revolving tower crane. The revolving tower crane shown in FIG. 1 can, for example, have a tower 1 in a manner known per se that carries a boom 2 that is balanced by a counter-boom 4 at which a counter-weight can be provided. Said boom 2 can be rotated by a slewing gear together with the counter-boom 4 about an upright axis of rotation 5 that can be coaxial to the longitudinal tower axis. A trolley 6 can be traveled at the boom 2 by a trolley drive, with a hoisting cable 7 to which a load hook 8 is fastened extending from the trolley 6.

As FIG. 1 likewise shows, the crane 2 can—obviously also as well as a development as a bridge crane or another crane—here have an electronic control apparatus 3 that can comprise a control processor arranged at the crane itself. Said control apparatus 3 can here control different adjustment members, hydraulic circuits, electric motors, drive apparatus, and other pieces of working equipment at the respective construction machine. In the crane shown, they can, for example, be its hoisting gear, its slewing gear, its trolley drive, its boom luffing drive—where present—or the like.

Said electronic control apparatus 3 can here communicate with an end device 9 that can be arranged at the control station or in the operator's cab and can, for example, have the form of a tablet with a touchscreen and/or joysticks, rotary knobs, slider switches, and similar operating elements so that, on the one hand, different information can be displayed by the control processor 3 at the end device 9 and conversely control commands can be input via the end device 9 into the control apparatus 3.

Said control apparatus 3 of the crane 10 can in particular be configured also to control said drive apparatuses of the hoisting gear, of the trolley, and of the slewing gear when an pendulum damping device 30 detects pendulum-relevant movement parameters.

For this purpose, the crane 1 can have a pendulum sensor or detection device 60 that detects an oblique pull of the hoisting cable 7 and/or deflections of the load hook 8 with respect to a vertical line 62 that passes through the suspension point of the load hook 8, i.e. the trolley 6. The cable pull angle β can in particular be detected with respect to the line of gravity effect, i.e. the vertical line 62, cf. FIG. 1.

In this regard, the pendulum sensor 60 may have a camera 63 or other imaging sensor system attached to the trolley 6 that looks perpendicularly downwardly from the trolley 6 so that, with a non-deflected load hook 8, its image reproduction is at the center of the image provided by the camera 63. If, however, the load hook 8 is deflected with respect to the vertical line 62, for example by a jerky traveling of the trolley 6 or by an abrupt braking of the slewing gear, the image reproduction of the load hook 8 moves out of the center of the camera image, which can be determined by an image evaluation device 61.

On the other hand the oblique pull β of the hoisting cable or the deflection of the load hook with respect to the vertical can also be achieved with the aid of an inertial measurement unit that is attached to the load hook 8 and that can preferably transmit its measurement signals wirelessly to a receiver at the trolley 6, cf. FIG. 1.

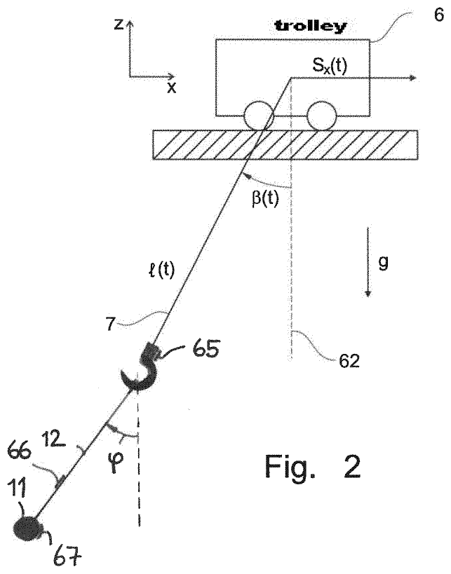

Furthermore, in order to detect the “lower” part of the double pendulum movements, more specifically the pendulum movements of the sling 12 and the load 11 attached thereto with respect to the load hook 8, the pendulum sensor 60 comprises an additional inertial measurement unit, which may be attached to said sling 12 or directly attached to the load 11. FIGS. 1 and 2 show an additional inertial measurement unit 66 on the sling 12 and another inertial measurement unit 67 attached directly to the load 11. By means of this at least one additional inertial measurement unit 66 and 67, in particular the deflection angle φ, which indicates the deflection of the sling 12 and the load 11 relative to the vertical 62 and thus relative to the load hook 8, can be determined.

Depending on the detected or determined deflections β and φ with respect to the vertical 62, in particular taking into account the direction and magnitude of the deflections, the control apparatus 3 can control the slewing gear drive and the trolley drive using the pendulum damping device 30 in order to bring the trolley 6 more or less precisely back over the load 11 and to compensate for double pendulum movements, or to reduce them, or to prevent them from occurring in the first place.

In particular, on the basis of the dynamics of the double pendulum, an observer can be determined, for example in the form of a Kalman filter, in particular an “unscented” Kalman filter, which can reliably determine the position of the load 11 and/or its deflection φ with the aid of the position of the load hook 8 or the measurements of said sensors in the form of the camera 63 and/or the inertial measurement unit 65 and the deflection β determined therefrom, on the one hand, and the additional pendulum sensor in the form of the inertial measurement unit 66 on the sling 12 and/or the inertial measurement unit 67 on the load 11, on the other hand. In particular, it is also possible to estimate the length of the sling 12 and thus the spacing of the load 11 from the load hook 8 as well as the angle φ between the vertical 62 and the sling 12 and to calculate the position of the load therefrom.

The basis for the observer is the mathematical description of the double pendulum. Taking into account the model shown in FIG. 2, the double pendulum dynamics can be derived with the help of the Euler-Lagrange equations. For simplicity, in the following there are considered only a pendulum plane and a crane without slewing gear, e.g. a bridge crane. However, the derivation can easily be extended to include another vibration plane and other drives such as a luffing or slewing gear.

First, the trolley position sₓ(t) the cable length l(t) as well as the upper and lower pendulum angle β(t) and φ(t) are defined as a function of time t, wherein in the following, for better readability, the time dependence is no longer specified specifically by the term (t). The position of the hook

$${r}_{H} = [ \begin{matrix}{s}_{x} - l sin ( β ) \\ - l cos ( β )\end{matrix} ] \qquad ( 1 )$$

and the load

$${r}_{L} = {r}_{H} + [ \begin{matrix}- {l}_{A} sin ( φ ) \\ {l}_{A} cos ( φ )\end{matrix} ] \qquad ( 2 )$$

and the associated velocities

$$\begin{matrix}{\dot{r}}_{H} = [ \begin{matrix}{\dot{s}}_{x} - \dot{l} sin ( β ) - l \dot{β } cos ( β ) \\ l \dot{β} sin ( β ) - \dot{l} cos ( β )\end{matrix} ] and & ( 3 ) \\ {\dot{r}}_{L} = [ \begin{matrix}{\dot{s}}_{x} - \dot{l} sin ( β ) - l \dot{β} cos ( β ) - \dot{φ} {l}_{A} cos ( φ ) \\ l \dot{β} sin ( β ) - \dot{l} cos ( β ) + \dot{φ} {l}_{A} sin ( φ )\end{matrix} ] & ( 4 )\end{matrix}$$

can be defined depending on these variables. The parameter l_{A} indicates the length of the sling. Depending on the design of the filter, this parameter can also be estimated online with, as will be explained later. The accelerations

$$\begin{matrix}{\ddot{r}}_{H} = [ \begin{matrix}{\ddot{s}}_{x} - sin ( β ) \ddot{l} - 2 \dot{l} \dot{β} cos ( β ) - \ddot{β} cos ( β ) l + \dot{{β}^{2}} l sin ( β ) \\ - \ddot{l} cos ( β ) + 2 sin ( β ) \dot{β} \dot{l} + cos ( β ) l \dot{{β}^{2}} + \ddot{β} l sin ( β )\end{matrix} ] and & ( 5 ) \\ {\ddot{r}}_{L} = [ \begin{matrix}{\ddot{s}}_{x} - \ddot{φ} {l}_{A} cos ( φ ) - sin ( β ) \ddot{l} - 2 \dot{l} \dot{β} cos ( β ) + {\dot{φ}}^{2} {l}_{A} sin ( φ ) - \ddot{β} cos ( β ) l + \dot{{β}^{2}} l sin ( β ) \\ - \ddot{l} cos ( β ) + 2 sin ( β ) \dot{β} \dot{l} + cos ( β ) l \dot{{β}^{2}} + {l}_{A} cos ( φ ) {\dot{φ}}^{2} + \ddot{φ} {l}_{a} sin ( φ ) + \ddot{β} l sin ( β )\end{matrix} ] & ( 6 )\end{matrix}$$

are not needed to derive the double pendulum dynamics, but can be used in the later observer design. With the help of the kinetic energy

T=½m_{H}\dot{r}_{H}^{T}\dot{r}_{H}+½m_{L}\dot{r}_{L}^{T}\dot{r}_{L} (7)

and the potential energy

V=[0g](m_{H}r_{H}+m_{L}r_{L}) (8)

via the solution of the Euler-Lagrange equation

$$\frac{d}{d t} \frac{\partial T}{\partial \dot{q}} - \frac{\partial T}{\partial q} + \frac{\partial V}{\partial q} = 0 \qquad ( 9 )$$

there can be derived the double pendulum dynamics with generalized coordinates q=[β,φ]^{T}. Due to the elongated expression, an explicit specification of the terms of \ddot{β} and \ddot{φ} is omitted. In a next step, from this there can be set up a nonlinear system in the state space

\dot{x}=ƒ(x,u)+w

y=h(x,u)+v (10)

with the states x=[β, \dot{β}, φ, \dot{φ}, l_{A}]^{T}, the inputs u=[sₓ, l, \dot{s}ₓ, \dot{l}, \ddot{s}ₓ, \ddot{l}]^{T} as well as with the system noise w=N(0, Q) and measurement noise v=N(0, R) assumed to be normally distributed over the covariance matrices Q and R. If the accelerations of the trolley \ddot{s}ₓ and the hoisting cable \ddot{l} are not available directly from the control system or via measurements or estimates as input for the observer, they can also be determined via a PT-1 approximation, as explained for example in WO 2019/007541. The outputs y depend on the available sensors. In the case of IMUs on the hook (65) and the load (67), for example, the accelerations y=[\ddot{r}_{H}, \ddot{r}_{L}]^{T} are suitable. In the case of the camera (63) and an IMU (67), the hook swing angle and the load acceleration determined via the camera can be used as output y=[β_{H}, \ddot{r}_{L}]^{T}. Alternatively or additionally, the rotation rate signals of the IMUs can be used in the outputs.

In this formulation, the system dynamics ƒ contains, in addition to the double pendulum dynamics, a random walk approach for the simultaneous estimation of the length of the sling with \dot{l}_{A}=0. For this system with the accelerations of the hook and the load in inertial coordinates, a stationary wheel observer can now be designed. In the nonlinear case, for example, an unscented or extended Kalman filter can be used. Depending on the system, the desired accuracy and the available computing power, a simplifying linearization in combination with a linear observer, e.g. a simple Kalman filter, can also be useful.

The following is an example of the procedure for an unscented Kalman filter using the hook and load acceleration as output y=[\ddot{r}_{H}, \ddot{r}_{L}]^{T}. First, at time step k, suitable sigma points χ=[χ₀, . . . , χ₂ₙ] and suitable weighting factors W=[W₀, . . . , W₂ₙ]

$${χ}_{0} ( k ) = \hat{x} ( k ) , {W}_{0} = \frac{κ}{n + κ} \\ {χ}_{i} ( k ) = \hat{x} ( k ) + {( \sqrt{( n + κ ) P ( k )} )}_{i} , {W}_{i + n} = \frac{1}{2 ( n + κ )} ; i = ( 1 , … , n ) \\ {χ}_{i + n} ( k ) = \hat{x} ( k ) - {( \sqrt{( n + κ ) P ( k )} )}_{i} , {W}_{i + n} = \frac{1}{2 ( n + κ )} \qquad ( 11 )$$

must be determined using the expected value \hat{x} of the system state x, the covariance matrix P, the design parameter κ and the system state n=5. The root of the matrix in equation (11) is not uniquely defined and must be determined via a Cholesky decomposition. Depending on the approach, the i-th column or i-th row is to be used in equation (11). Subsequently, the sigma points of the next sampling step k+1

χᵢ(k+1|k)=ƒ(χᵢ(k),u(k)) (12)

are predicted by applying the system equation (10). The predicted expected value is given by

\hat{x}(k+1|k)=Σᵢ₌₀²ⁿWᵢχᵢ(k+1|k). (13)

The estimation error covariance matrix is then obtained with the covariance of the process noise Q to give

$$P ( k + 1 \vert k ) = {\sum }_{i = 0}^{2 n} {W}_{i} ( {χ}_{i} ( k + 1 \vert k ) - \hat{x} ( k + 1 \vert k ) ) {( {χ}_{i} ( k + 1 \vert k ) - \hat{x} ( k + 1 \vert k ) )}^{T} Q . \qquad ( 14 )$$

The new Sigma points χᵢ(k+1|k) and weights Wᵢ can now be determined via equation (11) using P(k+1|k) and \hat{x}(k+1|k) instead of P(k) and \hat{x}(k). The sigma points predicted in this way can now be entered into the measuring range using the output equation (10),

Zᵢ(k+1|k)=h(χᵢ(k+1|k),u(k)) (15)

thereby predicting the measurements via the formation of the expected value

$$\hat{z} ( k + 1 \vert k ) = {\sum }_{i = 0}^{2 n} {W}_{i} {Z}_{i} ( k + 1 \vert k ) \qquad ( 16 )$$

Subsequently, the covariance matrix of the measurement noise R is used to determine the innovation covariance matrix

$$S ( k + 1 ) = {\sum }_{i = 0}^{2 n} {W}_{i} ( {Z}_{i} ( k + 1 \vert k ) - \hat{z} ( k + 1 \vert k ) ) {( {Z}_{i} ( k + 1 \vert k ) - \hat{z} ( k + 1 \vert k ) )}^{T} R . \qquad ( 17 )$$

With this and the cross-correlation matrix

$$T ( k + 1 ) = {\sum }_{i = 0}^{2 n} {W}_{i} ( {χ}_{i} ( k + 1 \vert k ) - \hat{x} ( k + 1 \vert k ) ) {( {Z}_{i} ( k + 1 \vert k ) - \hat{z} ( k + 1 \vert k ) )}^{T} R , \qquad ( 18 )$$

the Kalman matrix

K(k+1)=T(k+1)S⁻¹(k+1) (19)

can be determined and, together with the measured values z(k+1) the innovation of the expected value

\hat{x}(k+1|k+1)=\hat{x}(k+1|k)+K(k+1)(z(k+1)−\hat{z}(k+1|k)) (20)

and the estimation error covariance

P(k+1|k+1)=P(k+1|k)−K(k+1)S(k+1)K(k+1)^{T} (21)

can be carried out. With the estimated expected value of the states \hat{x}(k+1|k+1) the position of the hook and the load can be determined using equations (1) and (2).

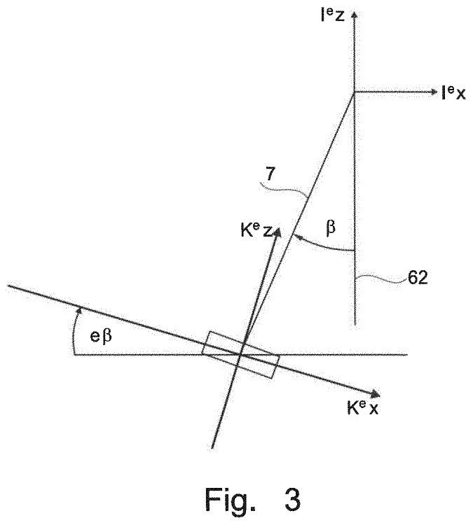

The measured values z(k+1) used in equation (20) can, as mentioned at the beginning of the filter description, be the accelerations of the hook \ddot{r}_{H} and the load \ddot{r}_{L} can be. In general, however, the measured accelerations of the IMUs (65) and (67) cannot be used directly, since the IMUs may be installed at an angle, or the load hook may be tilted by the angle ε_{β}, cf. FIG. 3. For this reason, the measured accelerations must be transposed into the inertial system. Orientation filters, which can be designed as EKF or complementary filters, are suitable for this purpose. An approach using a complementary filter is described, for example, in WO 2019/007541 and is roughly outlined again here for completeness.

The IMU measures all the signals in the co-moving, co-rotating body coordinate system of the load hook, which is characterized by the index K while vectors in inertial coordinates are characterized by I or also remain fully without an index. As soon as ϵ_{β} has been estimated, the measured acceleration a_{K}=[a_{K,x}, a_{K,z}]^{T} in load hook coordinates can be transformed into a_{I} in inertial coordinates, using

$${a}_{I} = {[ \begin{matrix}cos ( {ϵ}_{β} ) & sin ( {ϵ}_{β} ) \\ - sin ( {ϵ}_{β} ) & cos ( {ϵ}_{β} )\end{matrix} ]}^{T} {a}_{K} . \qquad ( 22 )$$

The inertial acceleration can then be used as a measured variable of the observer z or as output y of the system (10). In itself, the tilt could be estimated using a model corresponding to the simple integrator

\dot{ϵ}_{β}=ω_{β} (23)

from the measured rotation rate ω_{β} to the tilt angle. However, in the case of gyroscopic measurement of the rotation rate or tilt speed, the gyroscope signals have a time-variable offset and are superimposed by measurement noise, so the method described is not useful. Advantageously, it is therefore possible to work with an orientation filter.

The accelerometer is therefore used to provide a reference value for angle ϵ_{β} in that the acceleration due to gravity constant (that occurs in the signal having a low frequency) is evaluated and is known in inertial coordinates as

g_{I}=[0,−g]^{T} (24)

and can be transformed in load hook coordinates

g_{K}=−g[−sin(ϵ_{β})cos(ϵ_{β})]^{T} (25)

The measured acceleration results as the sum of (103) and (112)

a_{K}=\ddot{r}_{K}−g_{K} (26)

The negative sign of g_{K} here results from the circumstance that the acceleration due to gravity is measured as a fictitious upward acceleration due to the sensor principle. Since all the components of \ddot{r}_{K} are generally significantly smaller than g and oscillate about zero, the use of a lowpass filter having a sufficiently low masking frequency permits the approximation

a_{K}≈−g_{K} (27)

If the x-component a_{K,x} is divided by the z-component a_{K,z}, the reference tilt angle for low frequencies is obtained as

$${ϵ}_{β} = arctan ( \frac{{a}_{K , x}}{{a}_{K , z}} ) \qquad ( 28 )$$

The simple structure of the equations (23) and (28) permits the use of various filters to estimate the orientation. One option is a complementary filter, that can be set with respect to its frequency characteristic by a selection of the highpass and lowpass transfer functions.

A highpass filtering of the gyroscope signal ω_{β} with Gₕₚ(s) produces the offset-free rotational rate \tilde{ω}_{β} and, after integration, a first tilt angle estimate ϵ_{β,ω}. The further estimation ϵ_{β,a} comes from equation (28) based on the accelerometer. A simple highpass filter having the transfer function

$${G}_{h p} ( s ) = \frac{s}{s + {ω}_{0}} \qquad ( 29 )$$

and very low masking frequency ω₀ can in particular be applied to the gyro signal ω_{β} to eliminate the constant measurement offset. Integration produces the gyroscope based tilt angle estimate ϵ_{β,ω} that is relatively exact for high frequencies, but is relatively inexact for low frequencies. The underlying idea of the complementary filter is to sum up ϵ_{β,ω} and ϵ_{β,a} or to link them to one another, with the high frequencies of ϵ_{6β,ω} being weighted more by the use of highpass filter, and the low frequencies of ϵ_{β,a} being weighted more by the use of the lowpass filter

$${G}_{lp} ( s ) = \frac{{ω}_{0}}{s + {ω}_{0}} \qquad ( 30 )$$

since (28) represents a good estimate for low frequencies. The transfer functions can be selected as simple first order filters, where the masking frequency ω₀ is selected as lower than the pendulum frequency. Since

Gₕₚ(s)+Gₗₚ(s)=1 (31)

applies to all the frequencies, the estimate of ϵ_{β} is not incorrectly scaled.

The inertial acceleration a_{I} of the load hook can be determined on the basis of the estimated load hook orientation from the measurement of a_{K} and indeed while using (22), which permits the design of an observer on the basis of the double pendulum dynamics (10)

a_{I}=\ddot{r}_{I}−g_{I} (32)

Although both components of this equation can equally be used for the estimate of the pendulum angle, good results can also be obtained only using the x component that is independent of g.

The evaluation of the inertial measurement unit 65 and 66 or 67, which is attached to the sling 12 or directly to the load 11, can be carried out in an analogous manner as has just been explained. To avoid repetition, reference may be made to the statements just made.

Thus, the additional inertial measurement unit 66 or 67 on the sling 12 or the load 11 allows the position of the load 11 to be precisely determined even during double pendulum movements.

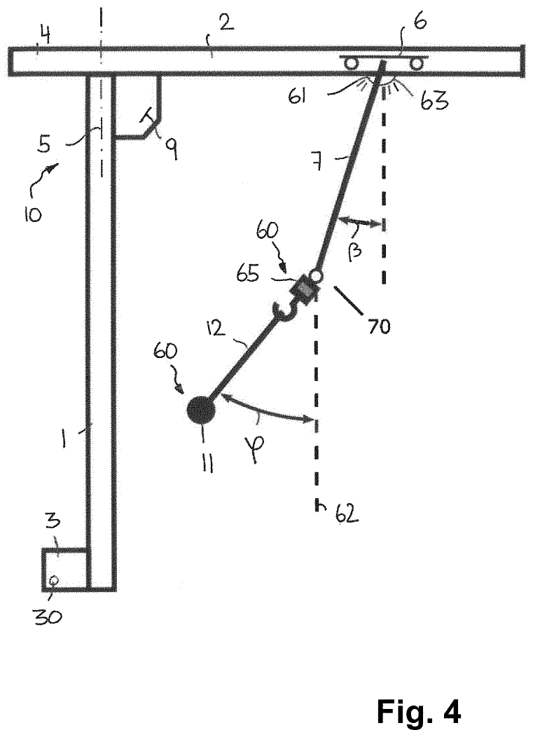

Depending on the type of crane and the design of the bottom hook block or load hook, the connection between the hoisting cable and the bottom hook block can be modeled using a pivot joint (70) and at the same time the connection between the load sling and the crane hook can be assumed to be fixed, as FIG. 4 shows. In this case, the tilting of the crane hook corresponds ϵ_{β} exactly to the lower pendulum angle φ. Consequently, in this constellation with a single IMU on the load hook, the position or pendulum angles of both the load hook and the length of the sling, and thus the position or pendulum angles of the load itself, can be determined. If necessary, the installation angle of the IMU must also be taken into account if its axes are not exactly aligned.

The tilt ϵ_{β} or the lower pendulum angle φ follows directly from the estimation of the orientation filter, which can be implemented e.g. as explained by a complementary filter. With regard to the observer, two implementations are conceivable depending on the quality of the orientation filter.

If the tilt ϵ_{β} estimated by the orientation filter is inaccurate or confused, it is advisable to use the entire double pendulum model (10) with the states x=[β, \dot{β}, φ, \dot{φ}, l_{A}]^{T} in the observer. In this constellation the outputs of the model y=[\ddot{r}_{H}, φ, \dot{φ}]^{T} can comprise, in addition to the accelerations of the hook, the tilt of the hook ϵ_{β}=φ as well as the rotation rate of the hook, which corresponds to the lower pendulum angular velocity, ω_{β}=\dot{φ} and serve as measurement variables z for the observer.

If the quality of the orientation filter is sufficiently high, the observer can be reduced. In this case, the state x=[β, \dot{β}, l_{A}]^{T} to be estimated is reduced to the upper pendulum angle β, the pendulum angular velocity \dot{β} and the length of the sling l_{A}. The lower pendulum angle φ and the angular velocity \dot{φ} are not states but inputs of the system. These thus result in u=[sₓ, l, \dot{s}ₓ, \dot{l}, \ddot{s}ₓ, \ddot{l}, φ, \dot{φ}]^{T}. The outputs of the model y=[\ddot{r}_{H}]^{T} can comprise the accelerations of the hook in this constellation and serve as measurement variables z for the observer. At this point it should be noted again that additionally or alternatively the rotation rates of the hook in the inertial system could be used.

Again, the length of the sling is estimated using a random walk approach. Alternatively, the length can also be transferred to the observer directly from outside or from a higher-level software module or by the user.

In advantageous further development, the described approach for describing the double pendulum dynamics and the indicated observers can be combined with a structural model of the crane, such as described in WO 2019/007541. The states determined in this way can be used for stabilization and to suppress unnecessary pendulums. For this purpose, a nonlinear control, e.g. a model predictive control (MPC), can be designed. For a simpler representation, a crane with a swing plane, e.g. a bridge crane, is used here as well. However, the method can easily be extended to include other vibration levels, e.g. a slewing gear, and structural elasticities.

In terms of model predictive control, the behavior of the crane is predicted using a mathematical model over a certain period of time and the manipulated variables are varied in such a way that a cost functional J, which describes the control objectives, is minimized.

This requires a mathematical model of the crane. However, in addition to the pendulum dynamics and any structural elasticities, this must also take into account the drive dynamics. Assuming a fast superimposed speed control of the inverters, the drive dynamics for the bridge crane considered for simplification results in

$${f}_{c o n t} ( x , u , {l}_{A} ) = [ \begin{matrix}{\dot{s}}_{x} \\ {\ddot{s}}_{x} \\ \dot{l} \\ \ddot{l} \\ \dot{β} \\ {f}_{1} ( x , u , {l}_{A} ) \\ \dot{φ} \\ {f}_{2} ( x , u , {l}_{A} )\end{matrix} ] \qquad ( 33 )$$

with the states x_{des}=[sₓ, \dot{s}ₓ, l, \dot{l}, β, \dot{β}, φ, \dot{φ}]^{T} and the inputs u_{des}=[\ddot{s}ₓ, \ddot{l}]^{T}. The functions ƒ₁(x, u) and ƒ₂ (x, u) describe the acceleration of the double pendulum angles analogous to the system (10). In addition, the structural dynamics of the crane could also be considered in (33).

A possible design of the cost functional

J(u;xₖ)=∫₀^{T}^{ₕₒᵣ}(x−x_{des})^{T}Q(x−x_{des})+(u−u_{des})^{T}R(u−u_{des})dt (34)

provides for x_{des}=[˜, \dot{s}_{x,des}, ˜, \dot{l}_{des}, 0,0,0,0]^{T} and u_{des}=[0,0]^{T} the penalization of the pendulum angles, the pendulum angle speed and the deviation of the trolley and hoist speeds from the desired target speeds \dot{s}_{x,des} and \dot{l}_{des} depending on the weighting matrices Q and R. The tilde indicates that no target values are specified for the trolley position and the hoisting cable length. Alternatively, other formulations are also conceivable, e.g. penalizing the deviation of the load or hook speed from a target. Formulations that penalize the deviation of the position of the hook, load or individual drives to a target position can also be implemented. On this basis it is possible to formulate the dynamic optimization problem

$${min}_{u ( \cdot )} J ( u ; {x}_{k} , {l}_{A} ) \\ u . B . v . \dot{x} = {f}_{c o n t} ( x ( t ) , u ( t ) , {l}_{A} ) , x ( {t}_{k} ) = {x}_{k} \\ {u}_{min} \leq u ( t ) \leq {u}_{max} , {x}_{min} \leq x ( t ) \leq {x}_{max} \qquad ( 35 )$$

This is solved in each sampling step via a numerical procedure, e.g. via common software tools such as ACADO or GRAMPC. The first part of the manipulated variable trajectory u(t) serves as input and is passed on to the inverters of the drives as setpoint speed after integration. In addition to the system dynamics, the optimization problem (35) directly includes the possibly time-varying constraints of the drives in the form of maximum and minimum acceleration in the manipulated variable constraints uₘₐₓ=[\ddot{s}_{x,max}, \ddot{l}ₘₐₓ]^{T} and uₘᵢₙ=[\ddot{s}_{x,min}, \ddot{l}ₘᵢₙ]^{T} as well as the maximum and minimum velocity and positions in the state constraints xₘᵢₙ=[s_{x,min}, \dot{s}_{x,min}, lₘᵢₙ, \dot{l}ₘᵢₙ, ˜, ˜, ˜, ˜]^{T} and xₘₐₓ=[s_{x,max}, \dot{s}_{x,max}, lₘₐₓ, \dot{l}ₘₐₓ, ˜, ˜, ˜, ˜]^{T}. This is a particular advantage of the MPC.

However, MPC involves a high computational cost, so that as an alternative to nonlinear control based on linearization of the model (33), a linear controller with gain scheduling, for example in the form of linear-quadratic control (LQR), can also be determined. Advantageously, this control can be combined with a trajectory generation and a feedforward control to form a two-degree-of-freedom control, as shown for example in WO 2019/007541 for a single pendulum.

We claim:

1. A revolving tower crane or boom crane comprising:
a hoisting cable extending from a crane boom and carries a load hook;
a sling having a load fixed thereto is rigged to the load hook, wherein the load hangs down, spaced apart from the load hook by the sling;
a determination device for determining the position and/or deflection of the load, wherein the determination device has a first determiner for determining a position and/or deflection of the load hook;
an electronic control apparatus for controlling drive devices for moving crane elements and relocating the load hook according to the detected position and/or deflection of the load; and
an inertial measurement device attached to the sling and/or the load, wherein the inertial measurement device comprises acceleration and rotation rate sensors for providing acceleration and rotation rate signals and a second determiner for determining and/or estimating a deflection and/or position of the load from the acceleration and rotation rate signals of the inertial measurement device, which is attached to the sling and/or to the load, and from the signals of the first determiner which characterize the position and/or deflection of the load hook.

2. The crane of claim 1, wherein the inertial measurement device on the sling and/or on the load comprises a wireless communication module to wirelessly transmit measuring signals and/or signals derived therefrom to a receiver, wherein the communication module and the receiver are connectable to each other via a Bluetooth or WLAN connection, and wherein the receiver is arranged on a trolley from which the hoisting cable extends.

3. The crane of claim 1, wherein the inertial measurement device on the sling and/or on the load has an energy accumulator comprising a rechargeable battery.

4. The crane of claim 1, wherein the inertial measurement device comprises a releasable fastener comprising a magnet device and/or a clamping device, wherein the releasable fastener is on the sling and/or on the load for releasable fastening to the load and/or to the sling.

5. The crane of claim 4, wherein the inertial measurement device is firmly integrated in the sling as a chain link.

6. The crane of claim 1, wherein the sling comprises at least one sling rope and/or sling chain.

7. The crane of claim 1, wherein the second determiner comprises a filter and/or observer device which is configured to take into account as an input variable a determined deflection and/or tilt of the sling and/or the load and determine the deflection of the sling and/or load relative to vertical from an inertial acceleration at the load and/or the sling.

8. The crane of claim 7, wherein the filter and/or observer device comprises an extended and/or unscented Kalman filter.

9. The crane of claim 1, wherein the first determiner for determining the position and/or deflection of the crane hook comprises an imaging sensor system comprising camera, which looks down substantially vertically in the region of a trolley having a suspension point of the hoisting cable, further comprising an image evaluation device for evaluating an image provided by the imaging sensor system with respect to the position of the load hook in the image provided and determining the deflection of the load hook and/or of the hoisting cable and/or the deflection speed with respect to vertical.

10. The crane of claim 9, wherein the first determiner comprises an inertial measurement device mounted on the load hook and having acceleration and rotation rate sensors for providing acceleration and rotation rate signals characterizing a translational acceleration and a rotation rate of the load hook.

11. The crane of claim 1, wherein the load hook is articulated to the hoisting cable in such a way that the deflection of the load hook corresponds to the deflection of the sling, wherein an inertial measurement device with acceleration and rotation rate sensors for providing acceleration and rotation rate signals is provided on the load hook and the determiner are configured for this purpose, determine and/or estimate the deflection and/or position of the load attached to the sling from the acceleration and rotation rate signals of said inertial measurement device on the load hook.

12. The crane of claim 11, wherein only the inertial measurement device is provided on the load hook and the determination and/or estimation of the deflection and/or position of the load rigged to the sling is performed without an inertial measurement device on the sling and the load.

13. The crane of claim 11, wherein a length of the sling is estimated and/or input and/or transferred via an external interface, wherein the deflection of the sling and/or the load relative to vertical is determined from the estimation of an orientation filter configured as a complementary filter.

14. A method for controlling a revolving tower crane or boom crane, on which on the load hook attached to a hoisting cable there is rigged a sling with a load attached thereto, comprising:
determining by a determining device the position and/or deflection of the load in dependence on the determined load position and/or deflection drive devices for moving crane elements;
controlling by an electronic control apparatus deflection drive devices for moving crane elements;
determining by the first determiner the position and/or deflection of the load hook;
determining by at least one inertial measurement device with acceleration and rotation rate sensors attached to the sling and/or on the load acceleration and rotation rate signals the translational accelerations and the rotation rates at the sling and/or at the load;
transmitting the translational accelerations and the rotation rates at the sling and/or at the load wirelessly to the control apparatus; and
determining by the first determiner a position and/or deflection of the load from the acceleration and rotation rate signals of the inertial measurement device and the position and/or deflection of the load hook.

15. The method of claim 14, wherein the deflection of the load and/or of the sling relative to vertical from an inertial acceleration at the load and/or at the sling by a filter and/or observer device to which the determined deflection of the load and/or of the sling is supplied as an input variable.

16. The method of claim 14, wherein the acceleration signals indicating the translational accelerations at the load and/or at the sling are determined with respect to three spatial axes and the rotation rate signals indicating the rotation rates at the load and/or the sling are detected with respect to at least two spatial axes.

17. The method of claim 14, wherein the load hook is articulated to the hoisting cable and is deflected with the same pendulum angle as the sling with respect to vertical;
providing by an inertial measurement device with acceleration and rotation rate sensors attached to the load hook acceleration and rotation rate signals indicating the translational accelerations and the rotation rates at the load hook;
transmitting wirelessly to the control apparatus the acceleration and rotation rate signals indicating the translational accelerations and the rotation rates at the load hook; and
determining a position and/or deflection of the sling and of the load from the acceleration and rotation rate signals of the inertial measurement device at the load hook.
